(19) United States
(12) Patent Application Publication
(10) Pub. No.: US 2009/0044007 A1
(43) Pub. Date: Feb. 12, 2009

(54) Secure Communication Between a Data Processing Device and a Security Module

(75) Inventors: Axel Ferrazzini, Paris (FR); Diego Anza, Madrid (ES); Pascal Chauvaud, Issy Les Mulineaux (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 11/918,190

(22) PCT Filed: Mar. 20, 2006
(86) PCT No.: PCT/FR2006/050240

§ 371 Date: May 12, 2008

(30) Foreign Application Priority Data
Apr. 7, 2005 (FR) 05 03471
Dec. 8, 2005 (FR) 05 53766

(51) Int. Cl. H04L 9/06

(52) U.S. Cl. 713/155

(57) ABSTRACT

A method of creating a secure link between a data processing device (MOB) and a security module (USIM), the data processing device being adapted to communicate with a security module storing a secret data item (k) necessary for the execution by the device of a data processing task, the data processing device and the security module being adapted to communicate with a telecommunications network (RES), wherein the method comprises the steps of: identifying the data processing device (MOB) and the module (USIM) for which a secure link is to be set up in order to send said secret data item (k) from the module to the device; a step of delivering an encryption key (K) in which a trusted server (SC) connected to the telecommunications network delivers an encryption key (K) both to the module (USIM) and to the data processing device (MOB) that have been identified; an encryption step in which said secret data item (k) is encrypted in the module by means of said encryption key (K); a transmission step in which the result of the encryption step is sent by the module (USIM) that has been identified to the device (MOB) that has been identified; and a decryption step in which the device (MOB) decrypts the result that has been received by means of said encryption key (K) that has been received and obtains said secret data item (k).

### FIELD OF THE INVENTION

The invention relates to secure communication between a data processing device and a security module storing secret data.

Generally speaking, the invention applies to any type of data processing device executing data processing tasks and needing, during the execution of those tasks, secret data stored in a security module with which it communicates. For example, the data processing device can be a server, a mobile telephone, a portable or fixed computer, a personal digital assistant (PDA), a home gateway of the LIVEBOX type (LIVEBOX is a registered trade mark of the Applicant), a decoder for access to a multimedia content, etc. In the example that is used to illustrate the invention, the data processing device is a mobile telephone providing access to a telecommunications network.

The communication between the data processing device and the module can be of any kind. It can be GSM (Global System for Mobile communications), WiFi, Bluetooth, Irda (Infrared Data Association) or other type wireless communication. The communication may also be PSTN (public switched telephone network), ADSL (asymmetric digital subscriber line), or other type cable communication. It may also be an electrical connection with electrical coupling between the data processing device and the module, where the module is a microchip module provided with electrical contacts. The communication may also be via a contactless connection, the module being a (passive or active) contactless module provided with data processing means and an antenna for communicating with the device. Or indeed, the communication may be a combination of some or all of the aforementioned types of communication.

The invention applies to any security module adapted to store secret data and to communicate with a data processing device of the aforementioned type. This module is removable and, as such, can therefore communicate as required with one of the aforementioned data processing devices. In the illustrative example chosen to illustrate the invention, the security module is a universal subscriber identity module (USIM) card coupled to a mobile telephone. A USIM stores secret data such as encryption keys that the telephone may need during execution of a data processing task. The invention is not limited to this type of card and encompasses any type of module for storing secret data that needs to be transmitted securely to a data processing device, for example a subscriber identity module (SIM) card (see GSM Technical Specification TS 51.011) or a UICC multi-application card (see Technical Specification TS 102.221 “Smart cards; UICC-Telephone interface; Physical and logical characteristics”) that stores secret data and can therefore require secure communication with the device to which it is connected. For all technical issues relating to the operation of SIM, USIM, and UICC modules see the GSM, UMTS, and SCP standards, respectively (in particular Technical Specification TS 102.223 for UICC administration commands).

The module can also be an access module to an encrypted multimedia content decoder. This type of module stores encryption keys to be sent to the decoder to decrypt an encrypted content.

### STATE OF THE ART

In the current standards, for example the GSM or UMTS standards, a distinction is made between a subscription to the telecommunications network and a data processing device, namely a mobile telephone. Mobile telephones are not dedicated devices, they have no configuration, and they are unusable on their own. It is necessary to add a SIM, USIM, or UICC card security module to them that stores in its memory all the data relating, for example, to a subscription, a personal password, the most recent numbers called, etc. Some of this data is secret and is used by the mobile telephone to execute a data processing task, for example to reconstitute scrambled content received from a content provider.

For example, third generation telephones now offer the possibility of providing services to users. A service can consist in displaying a multimedia content directly on the screen of a mobile telephone, for example. Such contents are paid for and are therefore intentionally scrambled by the content provider. The scrambling can consist in encrypting the multimedia content by means of an encryption key. Scrambling can also consist in extracting information bits from the initial multimedia content to render the content unreadable. The encryption keys or the missing information bits then constitute secret data that can be delivered to the user after payment of the content provider, and then stored in the security module.

For the device, reconstituting the content then consists in requesting from the module the secret data stored in it. The module sends back the requested secret data. On reception of the secret data, the device executes the data processing task that reconstitutes the initial content in order for the user to view it on the telephone. This reconstitution can consist in decryption by means of a decryption key, for example, or adding information bits extracted from the initial content.

The major problem is that the connection between the telephone and the security module is not secure. A malicious third party can therefore intercept messages in transit between the device and the module and extract the secret data from them. Knowing this data then makes it possible for that malicious third party to make fraudulent use of the rights of a legitimate user, without the content provider becoming aware of this. Even more seriously, the third party can circulate this secret data to other people. If that happens, the number of frauds increases exponentially, thereby creating a loss of income for the content provider.

### THE INVENTION

An object of the invention is to make communication between a security module and a data processing device secure, particularly for communicating secret data that is to remain confidential, regardless of the device to which the module is connected.

To this end, the invention provides a method of creating a secure link between a data processing device and a security module, the data processing device being adapted to communicate with a security module storing a secret data item k necessary for the execution by the device of a data processing task, the data processing device and the security module being adapted to communicate with a telecommunications network, the method being characterized in that it comprises the following steps:
a step of identifying the data processing device and the module for which a secure link is to be set up in order to send said secret data item k from the module to the device;
a step of delivering an encryption key K in which a trusted server connected to the telecommunications network delivers an encryption key K both to the module and to the data processing device that have been identified;
an encryption step in which said secret data item k is encrypted in the module by means of said encryption key K;
a transmission step in which the result of the encryption step is sent by the module that has been identified to the device that has been identified;
a decryption step in which the device decrypts the result that has been received by means of said encryption key K that has been received and obtains said secret data item k; and
a step of using said secret data item k to execute the data processing task.

The invention also provides the security module characterized in that it comprises:
receiver means adapted to receive an encryption key K;
encryption means adapted to encrypt a secret data item k by means of said encryption key K that has been received; and
transmission means for sending the result of encrypting said secret data item k to the device executing the data processing task.

The invention further provides the data processing device characterized in that it comprises:
receiver means adapted:
   to receive an encryption key K; and
   to receive the result of an encryption step performed by the module, the object of the encryption step being to encrypt said secret data item k by means of said encryption key K;
decryption means adapted to decrypt the result that has been received by means of said encryption key K that has been delivered in order to obtain said secret data item k; and
execution means adapted to use said secret data item k to execute the data processing task.

The invention further provides the trusted server characterized in that it comprises:
means for identifying the data processing device and the module for which a secure link must be set up for the transmission of said secret data item k from the module to the device;
means for delivering an encryption key K both to the module and to the data processing device that have been identified, the function of said key being to encrypt communication between the module and the device.

The invention further provides a computer program adapted to be executed on a trusted server, the program being characterized in that it comprises code instructions which perform the following steps when the program is executed in the trusted server:
a step of identifying the data processing device and the module for which a secure link must be set up for the transmission of the secret data item k from the module to the device;
a step of delivering an encryption key K in which the server delivers an encryption key K both to the module and to the data processing device that have been identified, said key having the function of encrypting communication between the module and the device.

The invention further provides a computer program adapted to be executed in a data processing device adapted to communicate with a security module storing a secret data item k necessary for the execution of a data processing task by the data processing device, the program being characterized in that it comprises code instructions that execute the following steps when the program is executed on the data processing device:
a step of receiving:
   an encryption key K; and
   the result of an encryption step performed by the module, the object of the encryption step being to encrypt said secret data item k by means of said encryption key K;
a step of decrypting the result that has been received by means of said encryption key K that has been delivered, in order to obtain said secret data item k; and
an execution step adapted to use said secret data item k to execute the data processing task.

Thus when a processing device begins a procedure to execute a task, for example to decrypt a scrambled content, a trusted server sends an encryption key both to the module and to the device in order to encrypt the transfer of secret data from the module to the device. Encrypted communication guarantees the confidentiality of secret data transmitted between the data processing device and the module.

This solution also has the advantage of making secure communication between a module and a set of data processing devices with which the module may be called on to communicate. An encryption key can advantageously be delivered at an opportune time. For example, if the module is removed from one data processing device and inserted into another device, the trusted server can, preferably immediately upon its insertion, deliver a new key both to the module and to that other data processing device to ensure the confidentiality of the secret data transmitted between that other device and the module.

The invention can be better understood on reading the following description which is given by way of example and with reference to the appended drawings.

### BRIEF DESCRIPTION OF THE DRAWINGS

FIG. 1 is a block diagram of a data processing system to which the invention can be applied.

FIG. 2 shows an algorithm illustrating the various steps of an implementation of the invention.

### DETAILED DESCRIPTION OF ONE ILLUSTRATIVE EMBODIMENT OF THE INVENTION

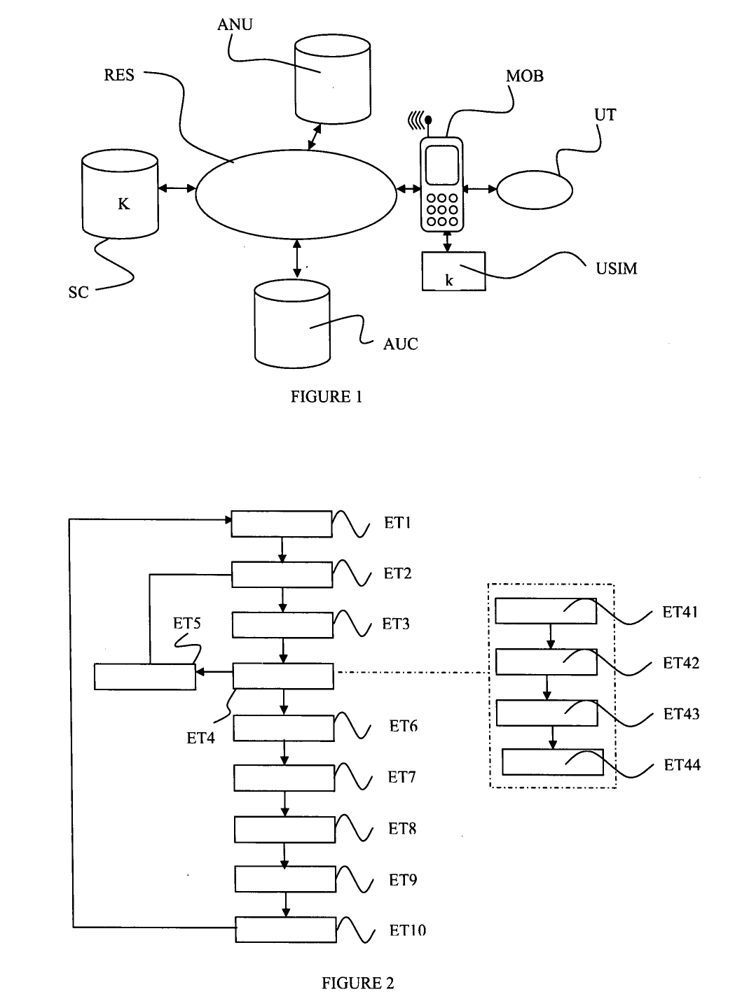

FIG. 1 represents a data processing system SYS in which the invention can be used. This figure represents:
a mobile telephone MOB coupled to a security module of the USIM card type; in this example the telephone is of the UMTS type;
a user UT of the mobile telephone who is a subscriber of a telecommunications operator for access to the data processing resources of a network RES by means of the mobile telephone MOB.

The telephone MOB includes processing means such as a processor adapted to execute computer programs to effect data processing tasks consisting, in this example, in reconstituting a content scrambled by means of a first encryption key k. In the example illustrated here, the scrambled content is an encrypted content supplied by a content provider FDC connected to the network RES.

The telephone MOB also includes storage means (not represented in FIG. 1) for storing data and applications and communication means (not represented in FIG. 1) for communicating with the telecommunications network RES.

Note that the example chosen to illustrate the invention is a simple one to enhance the understanding of the invention. This example is reduced to a single content encrypted by means of a single first encryption key k. The invention nevertheless and naturally applies to an unlimited number of encrypted contents, each of which contents can be encrypted by means of one or more encryption keys k.

The security module USIM includes processing means such as a processor adapted to execute computer programs. The security module USIM also includes storage means, in particular for storing secret data necessary for reconstituting the scrambled content stored in the telephone MOB. As indicated above, in this example, the secret data is a first encryption key k.

The security module USIM further includes means for communicating with the telecommunications network RES.

In this embodiment, the security module USIM is electrically connected to the telephone. Another embodiment could rely on communication between the security module USIM and a server that is connected to the network and adapted to execute a data processing task that requires knowledge of the secret data stored in the security module USIM in order to be executed. In this embodiment, communication between the security module USIM and the server is no longer direct, since the telephone, and where applicable other data processing devices, can be inserted between them.

According to the invention, a trusted server SC is connected to the network RES. The function of this trusted server is to deliver a second encryption key K both to the telephone and to the security module USIM. The function of the second encryption key K is to encrypt transmission of the first encryption key k from the security module USIM to the telephone MOB. In this example, only one second encryption key is sent. Of course, the invention is not limited to this example, and any number of second encryption keys K can be sent. For example, a plurality of second encryption keys can be used to encrypt a first encryption key k. For example, the trusted server can send a plurality of second encryption keys K in a block in order to reduce the number of messages sent to the module and to the device.

In the example illustrated here, this trusted server SC preferably includes means for authenticating the telephone MOB and the security module USIM. In this embodiment, the trusted server uses any useful information available to it to perform these authentications.

For a UMTS telephone, two types of authentication are possible, and can be used in conjunction to make authentication more reliable. A first type of authentication is verification of the validity of a certificate associated with the telephone MOB. That certificate is generally issued by a trusted entity ANU called a certification server known to the person skilled in the art (and also known as a public key architecture). That certification authority server ANU guarantees that a certificate stored in a telephone is valid and has not been revoked. The trusted server SC can then refer to this certification server ANU in order to determine if the certificate is valid and thus to authenticate the telephone. A second type of authentication is strong authentication. This second variant is explained below with reference to FIG. 2.

In this embodiment, authentication of the security module USIM is based on a pair IMSI/ki that is intimately linked to a security module USIM and is stored in the security module USIM and in an authentication server AUC. If a user UT wishes to access the network, the authentication server carries out a preliminary step of authenticating the security module USIM. This step verifies that the IMSI transmitted by the mobile telephone is correct. It therefore protects the operator against fraudulent use of its resources and protects the subscriber by preventing third parties from using the subscriber's account. The trusted server SC can then refer to this USIM card authentication server AUT in order to authenticate the security module USIM. For this purpose, in the example shown here, the trusted server SC includes means for communicating with the security module authentication server AUC. In this embodiment, the trusted server communicates with the telephone-module pair via a GSM mobile telephone network.

These steps of authenticating the telephone and the module assure the trusted server that the telephone-module pair is “trustworthy”.

The trusted server SC also includes means for communicating with the telephone-module pair in order to deliver the second encryption key K, which is preferably delivered after successful authentication of the telephone and the module. This preliminary authentication step is not obligatory but may be necessary as a function of the degree of security required for sending the second encryption key K.

The FIG. 2 algorithm comprises various steps illustrating an implementation of the method of the invention. In this implementation, it is assumed that the first encryption key k was stored in the security module USIM beforehand.

### Step 1

During a first step ET1, a security module USIM is coupled to a mobile telephone MOB. The telephone is switched on and the security module USIM is automatically authenticated by the authentication server AUT. This authentication step corresponds to that described above.

### Step 2

In this implementation, during a second step ET2, the user UT activates a service, for example by means of an interface in the telephone. In this example, the service consists in displaying a multimedia content on a screen of the telephone MOB. To this end, the provider downloads to the telephone MOB a multimedia content encrypted by means of the first encryption key k.

### Step 3

In this implementation, during a third step ET3, the telephone receives and stores the encrypted content, which can be decrypted either automatically without intervention of the user UT or at the request of the user UT.

In a variant of the invention, before decryption begins, a signal is sent to the trusted server SC to inform it that it is necessary to create a secure link between the telephone MOB and the security module USIM coupled to the telephone.

That signal can have various sources. Its source can be the telephone MOB, the security module USIM, the content provider or any other element of the network aware that the telephone needs to decrypt a content that was encrypted by means of a first encryption key k stored in the module.

The signal is preferably sent by the security module USIM. Because the security module USIM has already been authenticated by the network RES when the telephone MOB is switched on, it remains for the trusted server only to authenticate the telephone MOB. Under such circumstances, the telephone receives an encrypted content and sends a signal to the security module USIM informing it of the need to make the connection between the telephone MOB and the security module USIM secure. The module in turn sends a signal to the trusted server SC to inform it of this requirement.

In another variant, the telephone could be the initiator of the signal. Without sending any signal to the module, the telephone would send a signal directly to the trusted server SC to inform it of the need to make the connection between the telephone MOB and the security module USIM secure.

### Step 4

During a fourth step ET4, after identification of the telephone MOB and the security module USIM requiring a secure connection between them to be created, the trusted server SC authenticates the telephone MOB identified by the certification server ANU.

In this implementation, authentication of the telephone MOB consists in strong authentication by the trusted server SC that unfolds in several phases:
During a first phase ET41, the trusted server SC attempts to obtain from the telephone MOB at least its public key KPU in order to verify via the certification server ANU that the certificate associated with that public key is valid.

If so, during a second phase ET42, the trusted server SC sends the mobile telephone MOB a challenge.

During a third phase ET43, the mobile telephone responds by signing the challenge using the private key stored in its certificate.

During a fourth phase ET44, the trusted server SC receives the signed challenge and verifies the veracity of the signature with the public key obtained from the certificate received during the phase ET41.

If it transpires that the challenge was indeed signed by the correct sender, with a valid certificate, authentication succeeds, and the process can continue with the step ET6. If not, authentication fails, the consequence of which is that the user cannot use the service (cf. ET5).

### Step 5

During a fifth step ET5, if authentication of the telephone has failed, the trusted server SC does not continue the key delivery process. In this implementation, after an authentication failure, the user wishing to use the service is returned to the first step ET1 or the second step ET2.

### Step 6

If the authentication of the telephone MOB succeeds, the trusted server SC sends the second encryption key K both to the telephone and to the security module USIM in a sixth step ET6. In this example, this second encryption key K is encrypted by means of the public key KPU of the telephone and then sent to the telephone. Thus only the telephone is able to obtain the second key K by decrypting it using its private key.

This second encryption key K is also sent to the security module USIM. In this example, it is sent by means of an SMS message conforming to 3GPP Technical Specification TS 03.48. The SMS message is encrypted and can be decrypted only by the security module USIM.

### Step 7

During a seventh step E7, the security module USIM sends the telephone MOB the first encryption key k encrypted by means of the second encryption key K.

### Step 8

During an eighth step ET8, the telephone MOB receives the first key k encrypted by means of the second key K.

### Step 9

Having received the first key k encrypted by means of the second key K, the telephone decrypts it using the second encryption key K during a ninth step ET9. The telephone then decrypts the content encrypted with the first encryption key k. The user can then read the multimedia content.

### Step 10

During a tenth step ET10, the security module USIM is removed from the telephone MOB and inserted into another telephone. The process resumes in the same way at the first step ET2.

The key K is preferably a session key and is then usable only temporarily, for example for the identified telephone. If the module is inserted into another, different device, for example a PDA, another session key K′ is sent to the device.

Note that the order of execution of the steps described above is not limited to that of this implementation.

For example, authentication of the module in the step ET1 can take place at any time before the telephone decides to send the second encryption key K.

The fourth step ET4 can also take place before the third step ET3. Under such circumstances, authentication of the telephone takes place before the encrypted content is downloaded into the telephone.

It is therefore clear that the invention offers advantages over and above the main advantage explained above.

The implementation described relates to a direct connection between the data processing device and the module.

An indirect connection may nevertheless be envisaged, at least one other data processing device being interleaved between the data processing device and the module. That task being carried out by a data processing device that is not connected directly to the security module may be envisaged. For example, reverting the implementation described above, having the multimedia content decrypted on any server of the network and the telephone serving only to view what is decrypted by that server could be envisaged. Under such circumstances, the trusted server would send the second encryption key K to the server in question.

It has also been shown that the step of delivering the second encryption key is preceded by a step of the trusted server authenticating the data processing device and the module.

This two-fold authentication ensures that each participant, namely the data processing device that performs the data processing task and the module that stores the secret data, are trustworthy before any encryption key K is transferred. In this example, only one device requires a secure link with only one module. The necessity of securing a link between a plurality of modules and a plurality of data processing devices can nevertheless be envisaged, each module and each device contributing to the execution of the same data processing task. Under such circumstances, the number of authentications is, at best, equal to the number of devices and modules to which a secure connection relates.

In step 7 of this implementation, only one encryption key is sent to the telephone and to the module that have been identified. This example is not limiting on the invention, however, and for the same data processing task, for example reading a multimedia content, to be carried out by the device it may well be that a plurality of messages including secret data pass in transit from the module to the data processing device. In such a situation, with the aim of strengthening security, and preferably if the authentication of both the data processing device and the module has succeeded, the trusted server generates at least one session key as the encryption key K for performing the data processing task. The choice can be made to use a new session key to encrypt at best each message or at least some of the messages. This choice depends on the level of security required, in particular by the content provider.

It has also been shown that the above steps are carried for each data processing device and each module for which a secure connection must be set up to communicate the encryption key. This feature is also beneficial because, being removable, the module can be inserted into more than one type of data processing device, as required, each telephone being adapted to perform a particular data processing task. Thus the trusted server SC sends at least one second encryption key K for each device.

Finally, it has been shown that the identification step is preceded by sending a signal to the trusted server SC to inform it of the necessity to create a secure link between the device and the module. The initiator of that signal could be any data processing device aware of the need to encrypt communication between the device and the module.

1. A method of creating a secure link between a data processing device (MOB) and a security module (USIM), the data processing device being adapted to communicate with a security module storing a secret data item (k) necessary for the execution by the device of a data processing task, the data processing device and the security module being adapted to communicate with a telecommunications network (RES), wherein the method comprises the steps of:
a step of identifying the data processing device (MOB) and the module (USIM) for which a secure link is to be set up in order to send said secret data item (k) from the module to the device;
a step of delivering an encryption key (K) in which a trusted server (SC) connected to the telecommunications network delivers an encryption key (K) both to the module (USIM) and to the data processing device (MOB) that have been identified;
an encryption step in which said secret data item (k) is encrypted in the module by means of said encryption key (K);
a transmission step in which the result of the encryption step is sent by the module (USIM) that has been identified to the device (MOB) that has been identified; and
a decryption step in which the device (MOB) decrypts the result that has been received by means of said encryption key (K) that has been received and obtains said secret data item (k).

2. The method according to claim 1, wherein the link between the data processing device (MOB) and the module (USIM) is indirect, at least one other data processing device being interleaved between them.

3. The method according to claim 1, wherein the delivery step is preceded by a step of the trusted server (SC) authenticating the data processing device (MOB) and the module (UCIM).

4. The method according to claim 3, wherein the trusted server (SC) generates a session key as the encryption key (K) for performing the data processing task.

5. The method according to claim 1, wherein the above steps are effected for each data processing device (MOB) and each module (UCIM) for which a secure link must be set up to communicate said encryption key (K).

6. The method according to claim 1, wherein the identification step is preceded by sending a signal to the trusted server (SC) to inform it of the necessity to create a secure link between the device and the module.

7. A security module (USIM) adapted to communicate with a data processing device (MOB), said module storing a secret data item (k) necessary for execution of a data processing task by the data processing device, the data processing device (MOB) and the security module (USIM) being adapted to communicate with a telecommunications network (RES), wherein the module comprises:
receiver means adapted to receive an encryption key (K);
encryption means adapted to encrypt said secret data item (k) by means of said encryption key (K) that has been received; and
transmission means adapted to send the result of encrypting said secret data item (k) to the device (MOB) executing the data processing task.

8. A data processing device (MOB) adapted to communicate with a security module (USIM) storing a secret data item (k) necessary for the execution of a data processing task by the device, the data processing device and the security module being adapted to communicate with a telecommunications network (RES), wherein the device comprises:
receiver means adapted:
to receive an encryption key (K); and
to receive the result of an encryption step performed by the module (USIM), the object of the encryption step being to encrypt said secret data item (k) by means of said encryption key (K);
decryption means adapted to decrypt the result that has been received by means of said encryption key (K) that has been delivered in order to obtain said secret data item (k); and
execution means adapted to use said secret data item (k) to execute the data processing task.

9. A trusted server (SC) adapted to communicate with a data processing device (MOB) and a security module (USIM) storing at least one secret data item (k) necessary for the execution of a data processing task by the data processing device, the data processing device (MOB) and the security module (USIM) being adapted to communicate with a telecommunications network (RES), wherein the server comprises:
means for identifying the data processing device (MOB) and the module (USIM) for which a secure link must be set up for the transmission of said secret data item (k) from the module to the device; and
means for delivering an encryption key (K) both to the module (USIM) and to the data processing device (MOB) that have been identified, the function of said key being to encrypt communication between the module and the device.

10. A computer program adapted to be executed on a trusted server (SC), said server being adapted to communicate with a data processing device (MOB) and a security module (USIM) storing a secret data item (k) necessary for the execution of a data processing task by the data processing device, wherein the program comprises code instructions which perform the following steps when the program is executed in the trusted server:
a step of identifying the data processing device (MOB) and the module (USIM) for which a secure link must be set up for the transmission of the secret data item (k) from the module to the device;
a step of delivering an encryption key (K) in which the server (SC) delivers an encryption key (K) both to the module (USIM) and to the data processing device (MOB) that have been identified, said key having the function of encrypting communication between the module (USIM) and the device (MOB).

11. A computer program adapted to be executed in a data processing device (MOB), said device being adapted to communicate with a security module (USIM) storing a secret data item (k) necessary for the execution of a data processing task by the data processing device, wherein the program comprises code instructions that execute the following steps when the program is executed on the data processing device:
a step of receiving:
an encryption key (K); and
the result of an encryption step performed by the module (USIM), the object of the encryption step being to encrypt said secret data item (k) by means of said encryption key (K);
a step of decrypting the result that has been received by means of said encryption key (K) that has been delivered, in order to obtain said secret data item (k).
